(19) United States
(12) Patent Application Publication
(10) Pub. No.: US 2006/0098697 A1
(43) Pub. Date: May 11, 2006

(54) Wavelength tunable light source module for wavelength division multiplexing passive optical network system

(76) Inventors: Byoung Whi Kim, Daejeon (KR); Woo Ram Lee, Daejeon (KR); Jae Dong Park, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/120,919

(22) Filed: May 2, 2005

(30) Foreign Application Priority Data
Nov. 8, 2004 (KR) 10-2004-90327

(51) Int. Cl. H01S 3/10

(52) U.S. Cl. 372/20

(57) ABSTRACT

Disclosed is a wavelength tunable light source module for wavelength division multiplexing passive optical network systems, which is capable of being realizing at low costs, increasing utility of wavelength resources, and facilitating mass production. The wavelength tunable light source module comprising: a temperature adjustment unit for raising or lowering ambient temperature according to heat generation or heat absorption caused by an electrical signal, a support block attached to the temperature adjustment unit and having a structure for fixing a laser diode, and a TO-can type distributed feedback laser diode mounted on the temperature adjustment unit by the support block and having an operation wavelength varied according to the ambient temperature adjusted by the temperature adjustment unit.

### RELATED APPLICATIONS

The present application is based on, and claims priority from, Korean Application Number 2004-90327, filed Nov. 8, 2004, the disclosure of which is hereby incorporated by reference herein in its entirety.

### BACKGROUND OF THE INVENTION

1. Field of the Invention

The present invention relates to a wavelength tunable light source module for wavelength division multiplexing passive optical network systems, which is capable of being realized at low costs, increasing utility of wavelength resources, and providing easiness in mass production.

2. Description of the Related Art

In general, since a wavelength division multiplexing passive optical network (WDM-PON) conducts communication between a central office and optical network units of subscribers using a unique wavelength assigned for each subscriber, it can provide independent communication services and sufficient channel bandwidths for more subscribers using less optical fibers. Moreover, the WDM-PON has an additional advantage of high communication security.

Thus, in the WDM-PON, since light sources having different wavelengths for different subscribers must be set, it will be of advantage if the wavelength interval between channels can be shortened within a tolerance limit of cross talk due to adjacent channel interference in order to accommodate a great number of communication channels in a defined frequency band.

A light source satisfying such a condition includes a cooled butterfly-typed distributed feedback laser diode (hereinafter, referred to as ‘DFB-LD’) containing a thermistor having resistance varied with temperature for measuring a current temperature and a thermo electric cooler (TEC) for controlling temperature through a heating or cooling operation. However, the cooled DFB-LD must employ an expensive butterfly-type package, raising the unit cost of parts, and thus it is difficult to employ the cooled DFB-LD for optical network systems placing importance on low costs.

For existing optical network systems, a coarse wavelength division multiplexing (CWDM)-PON using an uncooled light module without a need of wavelength control for the purpose of reducing the unit cost has been proposed. However, the CWDM-PON employs an uncooled TO-can type DFB-LD as a light source and uses a wide wavelength interval of 20 nm to allow wavelength shift of a laser diode with the variation of environmental temperature, the number of wavelengths, which can be accommodated within a defined wavelength band, is limited. Moreover, since variation of loss characteristics of an optical fiber is great depending on wavelengths, power supplied to a receiver is greatly varied for each channel. As a result, there arises a problem of difficulty and excessive costs in establishment of the optical network systems.

### SUMMARY OF THE INVENTION

Therefore, the present invention has been made in light of the above described problems, and it is an object of the present invention to provide a wavelength tunable light source module for wavelength division multiplexing passive optical network systems, which is capable of being realized at low costs, increasing utility of wavelength resources, and facilitating mass production while stabilizing wavelengths of optical signals through temperature compensation.

In accordance with an aspect of the present invention, the above and other objects can be accomplished by the provision of a wavelength tunable light source module comprising: a temperature adjustment unit for raising or lowering environmental temperature according to heat generation or heat absorption caused by an electrical signal; a support block attached to the temperature adjustment unit and having a structure for fixing a laser diode; and a distributed feedback laser diode mounted on the temperature adjustment unit by the support block and having an operation wavelength varied according to the ambient temperature adjusted by the temperature adjustment unit.

Preferably, the distributed feedback laser diode is an uncooled TO-can type distributed feedback laser diode. With this configuration, the unit cost of production of the wavelength tunable light source module can be reduced.

Preferably, the support block is made of metal material having high thermal conductivity to easily transfer temperature adjusted by the temperature adjustment unit to the laser diode.

Preferably, the temperature adjustment unit comprises a thermal electric cooler attached to the bottom of the support block for generating or absorbing heat when a direct current power is applied and lowering operation temperature of the distributed feedback laser diode; and a base attached on the bottom of the thermal electric cooler and made of material having high thermal conductivity or heat sink for convection of heat generated when the thermal electric cooler is operated. With this configuration, the operation wavelength can be varied by varying the operation temperature of the distributed feedback laser diode.

Preferably, the temperature adjustment unit comprises a heater chip attached on the bottom of the support block for raising the ambient temperature by generating heat by an operation power, the heater chip containing a temperature measurement device. With this configuration, the operation wavelength can be adjusted by raising the operation temperature.

Preferably, the temperature adjustment unit, the support block, and the distributed feedback laser diode are mutually bonded by means of a thermal compound having good thermal conductivity or an epoxy resin. With this configuration, good thermal conduction between components of the wavelength tunable light source module can be attained.

Preferably, the support block has a rectangular parallelepiped fixation groove for fixing the distributed feedback laser diode, the wavelength tunable light source module further comprises a thermistor mounted on the support block for measuring the operation temperature of the distributed feedback laser diode. With this configuration, by feeding back the current operation temperature of the distributed feedback laser diode, the operation wavelength of the distributed feedback laser diode can be accurately controlled.

Preferably, the wavelength tunable light source module having the temperature adjustment unit implemented by the thermal electric cooler further comprises an adiabatic cover made of a material having low thermal conductivity for isolating the support block from the external environments. With this configuration, the operation temperature of the distributed feedback laser diode can be easily controlled. At this time, by filling a space between the support block and the adiabatic cover with an adiabatic material, an adiabatic effect can be further enhanced.

Preferably, the wavelength tunable light source module of the present invention further comprises a temperature control circuit for receiving a temperature measurement value of the temperature measurement device or the thermistor, detecting a difference between a reference temperature and the temperature measurement value, and controlling the temperature adjustment unit such that the operation temperature of the distributed feedback laser diode is maintained at the reference temperature.

In accordance with another aspect of the present invention, the above and other objects can be accomplished by the provision of a wavelength division multiplexing passive optical network system including an optical line terminal and optical network units, containing the wavelength tunable light source module of the present invention for generating optical signals having preset unique wavelengths for each channel.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing a top view, a side view and a front view of a wavelength tunable light source module according to a first embodiment of the present invention;

FIG. 2 is a diagram showing a top view, a side view and a front view of a wavelength tunable light source module according to a second embodiment of the present invention;

FIGS. 3a and 3b are top view and side view illustrating an application example of a wavelength tunable light source module according to the present invention;

FIG. 4 is a diagram illustrating an example of a control circuit of FIGS. 3a and 3b;

FIG. 5 is a diagram illustrating a bi-directional wavelength division multiplexing passive optical network system to which the wavelength tunable light source module according to the present invention is applied;

FIG. 6 is a diagram illustrating another wavelength division multiplexing passive optical network system to which the wavelength tunable light source module according to the present invention is applied;

FIG. 7 is a diagram illustrating a fiber-to-the-pole type wavelength division multiplexing passive optical network system to which the wavelength tunable light source module according to the present invention is applied; and

FIG. 8 is a diagram illustrating a fiber-to-the-home type optical network system in the form of an active optical network (AON) to which the wavelength tunable light source module according to the present invention is applied.

### DESCRIPTION OF THE PREFERRED EMBODIMENTS

Hereinafter, preferred embodiments of the present invention will be described in detail with reference to the accompanying drawings, so that the present invention can be easily practiced by those skilled in the art. Throughout the drawings, like elements are denoted by like reference numerals.

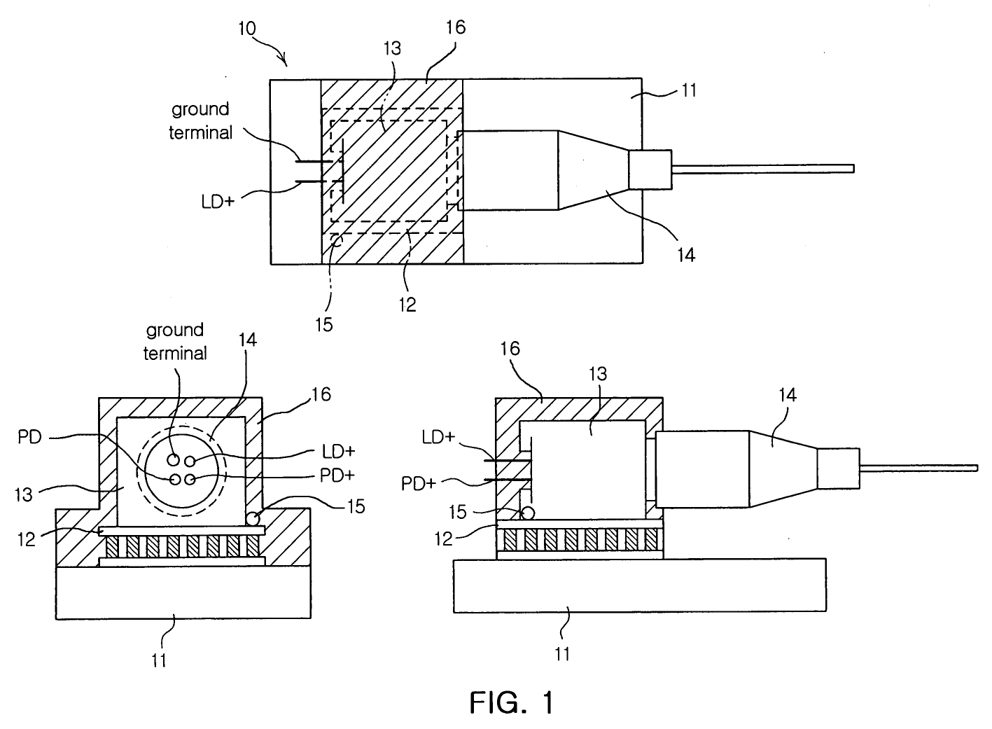

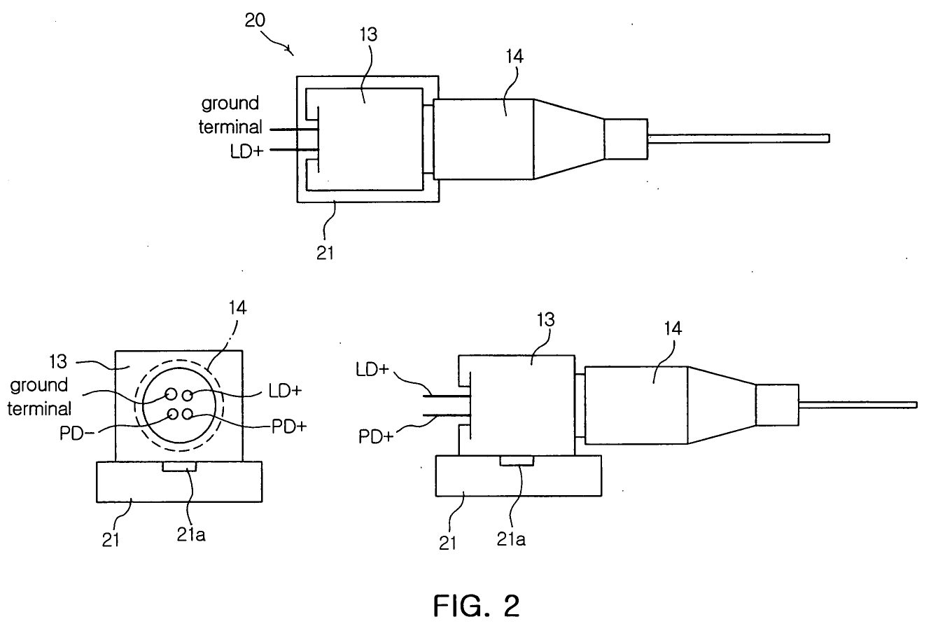

A wavelength tunable light source module according to the present invention controls an operation wavelength within a tolerance limit of a distributed feedback laser diode (DFB-LD) using a temperature control means mounted on an uncooled TO-can type DFB-LD in order to implement an inexpensive wavelength tunable light source module. FIGS. 1 and 2 show the wavelength tunable light source module according to embodiments of the present invention.

FIG. 1 is a diagram showing a top view, a side view and a front view of a wavelength tunable light source module according to a first embodiment of the present invention. Referring to FIG. 1, a wavelength tunable light source module 10 of the present invention includes a base 11 having a structure on which a light source is mounted, and which is made of material having high thermal conductivity or heat sink for ejecting heat emitted from a thermal electric cooler 12, the thermal electric cooler 12 being mounted on the base 11 for controlling temperature using heat generation or heat absorption caused by a direct current power applied externally, a support block 13 fixed on the top surface of the thermal electric cooler 12 and having a fixation groove for fixing a TO-can type DFB-LD 14 substantially in parallel with the base 11, the TO-can type DFB-LD 14 being fixed on the support block 13 for emitting light having a certain wavelength according to variation of operation temperature by the thermal electric cooler 12, and a thermistor 15 fixed on the support block 13 in proximity to the DFB-LD 14 for measuring the operation temperature of the DFB-LD 14.

Reference numeral 16 in FIG. 1 denotes an adiabatic cover.

The thermal electric cooler 12 is composed of n-type and p-type semiconductors, which are connected electrically in series and thermally in parallel, for controlling temperature using heat generation/absorption caused by a Peltier effect. In the operation of the thermal electric cooler 12, when a direct current is applied to the thermal electric cooler 12, there occurs a difference in potential energy between electrons in the n-type semiconductor and those in the p-type semiconductor. Due to the difference in potential energy, thermal energy is absorbed in a contact point and is ejected toward an opposite direction of the contact point such that electrons are moved from metal having low potential energy to metal having high potential energy. When the direct current is applied in a reverse direction, the flow of electrons is reversed, and accordingly, positions of the heat generation and absorption are reversed. The heat generated when the thermal electric cooler 12 is operated is ejected through the base 11 formed under the thermal electric cooler 12 and made of material having high thermal conductivity or heat sink, and the operation temperature of the DFB-LD 14 fixed on the thermal electric cooler 12 by the support block 13 is varied due to the heat absorption of the thermal electric cooler 12.

At this time, the support block 13 is preferably made of metal material having high thermal conductivity, such as aluminum, such that the thermal electric cooler 12 can easily control the temperature of the DFB-LD 14.

In addition, the base 11, the thermal electric cooler 12, the support block 13, the DFB-LD 14, and the thermistor 15 are mutually bonded by means of a thermal compound having good thermal conductivity or an epoxy resin.

The thermal electric cooler 12 adjusts environmental temperature of the DFB-LD 14 within a predetermined temperature range below the normal room temperature. According to such a temperature adjustment, operational characteristics of the DFB-LD 14 can be minutely controlled, that is, a wavelength of light emitted from the DFB-LD 14 can be controlled to be maintained at a constant value. The wavelength of light emitted from the DFB-LD 14 can be adjusted by controlling the direct current applied to the thermal electric cooler 12. In addition, the thermistor 15 measures the operation temperature of the DFB-LD 14 adjusted by the thermal electric cooler 12. Accordingly, based on a relationship between the operation wavelength and the temperature of the DFB-LD 14, the wavelength of light emitted from the DFB-LD 14 can be adjusted by controlling the direct current applied to the thermal electric cooler 12 according to the operation temperature measured by the thermistor 15.

Accordingly, the wavelength tunable light source module 10 can be implemented by a temperature-compensable light source module using the TO-can type DFB-LD, which is cheaper than the conventional butterfly-type DFB-LD. In addition, since it is possible to tune the wavelength light emitted from the DFB-LD 14 according to the temperature control using the thermal electric cooler 12 and the thermistor 15, a number of optical network units can be accommodated in the limited number of optical transmission lines, which results in an inexpensive WDM-PON.

In the first embodiment of the present invention as shown in FIG. 1, since the operation temperature of the DFB-LD 14 is adjusted by the heat absorption within a temperature range below the normal room temperature, the operation temperature of the DFB-LD 14 is apt to rise due to environmental air over the normal room temperature although it is lowered by the thermal electric cooler 12. Accordingly, an adiabatic cover 16 enclosing the entire structure including the thermal electric cooler 12, the support block 13, the DFB-LD 14, and the thermistor 15 is preferably provided so that the thermal electric cooler 12 controls the operation temperature accurately under an insignificant influence of environmental temperature.

The adiabatic cover 16 prevents the temperature lowered by the thermal electric cooler 12 from rising again by isolating the thermal electric cooler 12, the support block 13, the DFB-LD 14, and the thermistor 15 from the surroundings. In addition, the adiabatic cover 16 separates the support block 13 from the atmosphere and is made of material having poor thermal conductivity, such as plastic. In addition, an adiabatic effect can be further enhanced by filling a space between the support block 13 and the adiabatic cover 16 with an adiabatic material such as paper.

FIG. 2 shows a second embodiment of the present invention, where a wavelength tunable light source module employs a heater chip as a temperature control means, instead of the thermal electric cooler.

Referring to a top view, a side view and a front view in FIG. 2, a wavelength tunable light source module 200 according the second embodiment of the present invention includes a heater chip 21 generating heat by an operation power applied externally and containing a temperature measurement device 21a for measuring the temperature of the heater chip 21, a support block 13 fixed on the top surface of the heater chip 21 for fixing a TO-can type DFB-LD 14 substantially in parallel with the heater chip 21, and the TO-can type DFB-LD 14 fixed on the support block 13 for emitting light having a certain wavelength corresponding to operation temperature adjusted by the heater chip 21.

In the first embodiment as shown in FIG. 1, since the thermal electric cooler 12 adjusts the operation temperature using the heat absorption, the base 11 must have the heat sink structure or must be made of a thermally conductive material such that the heat generated by the thermal electric cooler 12 can be radiated. However, in the second embodiment as shown in FIG. 2, since the heater chip 21 adjusts the operation temperature using the heat generation, it is preferable that the heater chip 21 is bonded to only the support block 13 of the DFB-LD 14, such that a heat area can be minimized to reduce a thermal loss. Accordingly, the base 11 shown in FIG. 1 can be omitted in FIG. 2. In this case, the heater chip 21, the support 13, and the TO-can type DFB-LD 14 are mutually bonded by means of a thermal compound having good thermal conductivity or an epoxy resin, as in the first embodiment.

Since the heater chip 21 contains the temperature measurement device 21a, a thermistor need not be separately provided for the DFB-LD 14.

In the second embodiment as shown in FIG. 2, a subminiature coaxial (SMA) connector for supplying electric power to the heater chip 21 is further required, and a variable resistor for setting heat temperature of the heater chip 21 may be further provided. In this case, an electrical circuit connects the heater chip 21 to each other.

When compared to the wavelength tunable light source module 10 of the first embodiment, the wavelength tunable light source module 20 of the second embodiment has a disadvantage in that the operation temperature of the DFB-LD 14 must be set to be higher than the normal room temperature, but an advantage in that the wavelength tunable light source module 20 can be configured in a simpler form.

The wavelength tunable light source modules as shown in FIGS. 1 and 2 can be configured as a package further including a temperature control circuit for controlling the operation of the thermal electric cooler 12 or the heater chip 21 by feeding back the temperature measured using the thermistor 15 or the temperature measurement device 21a according to wavelength tunable characteristics depending on the operation temperature of the DFB-LD 14.

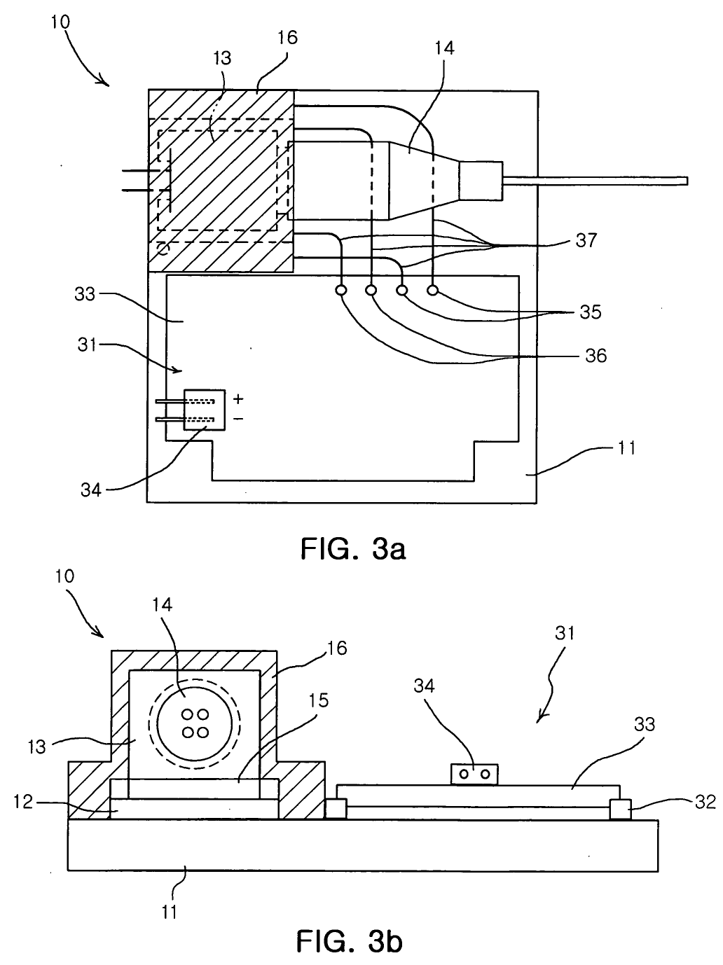

FIGS. 3a and 3b show a structure where a temperature control unit is added to the wavelength tunable light source module according to the first embodiment.

Referring to FIGS. 3a and 3b, the wavelength tunable light source module 10 including the thermal electric cooler 12, the support block 13, the DFB-LD 14, the thermistor 15, and the adiabatic cover 16 is mounted on a portion of the base 11 having heat ejection function, as shown in FIG. 1, and a temperature control unit 31 is formed on remaining portions of the base 11.

The temperature control unit 31 includes a printed circuit board 33 on which a temperature control circuit for detecting a resistance value corresponding to the temperature measured by the thermistor 15 and adjusting an amount of current applied to the thermal electric cooler 12, such that temperature around the light source module 10 can be maintained constant, is formed, a power supply pin 34 formed on the printed circuit board 33 for supplying electric power to the temperature control circuit, and connection terminals 35 and 36 formed on the printed circuit board 33 for electrically connecting the temperature control circuit to the thermal electric cooler 12 and the thermistor 15.

The connection terminals 35 and 36 are connected respectively to the thermal electric cooler 12 and the thermistor 15 through respective cables 37 or other electrical connection means.

The printed circuit board 33 can be fixed on the base 11 having the heat ejection function through a support member 32.

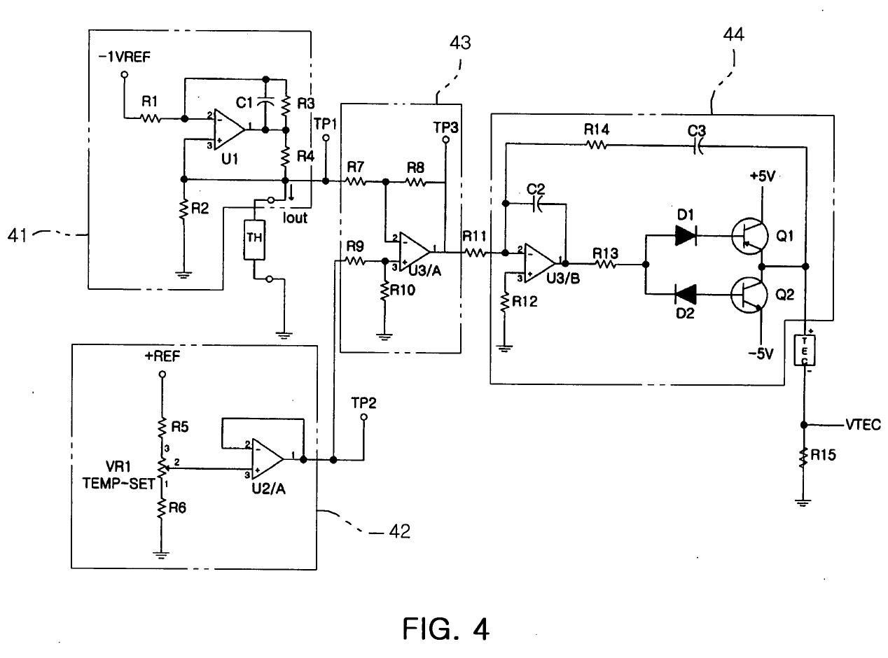

The temperature control circuit formed on the printed circuit board 33 can be configured as shown in FIG. 4.

Referring to FIG. 4, the temperature control circuit comprises a constant current circuit 41 for detecting a variation in resistance of the thermistor 15 depending on temperature by causing constant current to flow into the thermistor 15, a reference temperature setting unit 42 including a variable resistor VR1 adjustable in correspondence to reference temperature for outputting a value of resistance of the variable resistor VR1 as a voltage signal, a comparing unit 43 for comparing a voltage across a resistor of the thermistor 15 with the reference voltage outputted from the reference temperature setting unit 42 and outputting a difference between the voltage and the reference voltage, a control output unit 44 for adjusting the amount of current applied to the thermal electric cooler 12 based on the voltage difference outputted from the comparing unit 43.

The control output unit 44 comprises an integration circuit for performing a proportional integration on an output of the comparing unit 43, and a current driving circuit operating according to an output of the integration circuit. The control output unit 44 adjusts heat absorption temperature of the thermal electric cooler 12 by adjusting the amount of driving current of the thermal electric cooler 12.

The temperature control circuit shown in FIG. 4 is provided as one example for implementation of the wavelength tunable light source package, and may be modified for user need and control purpose.

The above-described configuration of the package can be applied to the second embodiment shown in FIG. 2 in the same way as the first embodiment.

The wavelength tunable light source module of the present invention can be employed for the optical network system, allowing implementation of the system with inexpensive costs.

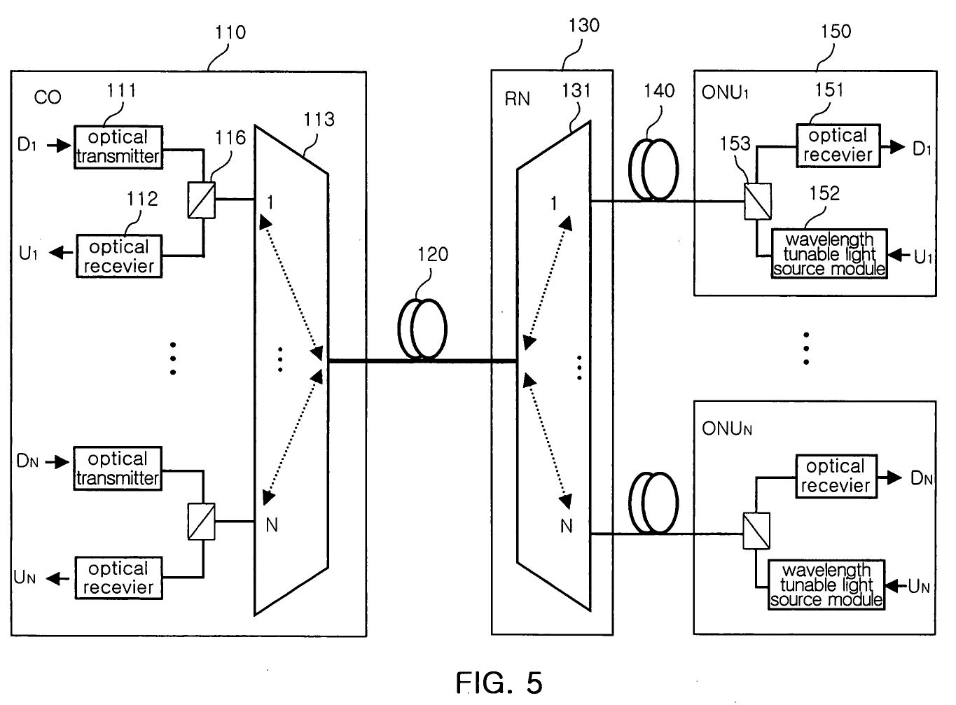

FIGS. 5 to 8 are diagrams illustrating various embodiments of the configuration of optical network systems implemented using the wavelength tunable light source module of the present invention.

FIG. 5 shows a high density WDM-PON.

Referring to FIG. 5, the high density WDM-PON of the present invention comprises a central base station 110 for transmitting downward data received from different networks or servers (not shown) as an optical signal and converting received optical signals to upward data to transmit the different networks or servers, a first optical fiber 120 connected between the central base station 110 and subscribers for transmitting upward and downward optical signals having different wavelengths, a remote node 130 provided at terminations of the subscribers connected to the first optical fiber 120 for distributing downward signals transmitted from the first optical fiber 120 for each optical network unit, multiplexing upward signals having different wavelengths from each subscriber, and transmitting the multiplexing upward signals to the first optical fiber 120, a plurality of second optical fibers 140 connected between the remote node 130 and a plurality of optical network units (ONU) 150, respectively, for transmitting upward/downward optical signals for each subscriber, and the plurality of ONUs 150 provided at terminations of the plurality of second optical fibers 140 for converting the upward signals from subscribers to optical signals having preset wavelengths and converting received optical signals having certain wavelengths to electrical signals to be transmitted to the subscribers. Wavelength tunable light source modules having different wavelengths according to the present invention are provided in the plurality of ONUs 150 at the subscribers, respectively.

In more detail, each ONU 150 includes an optical receiver 151 for converting a received optical signal having a certain wavelength to an electrical signal, the wavelength tunable light source module 152 as shown in FIG. 1 or 2, and a CWDM filter 153 for connecting a pair of the optical receiver 151 and the wavelength tunable light source module 152 to a corresponding second optical fiber 140 and filtering upward and downward channels. Each optical receiver 151 of the ONU 150 converts downward optical signals inputted through the second optical fiber 140 to respective data D_{1-N} to be transmitted to a subscriber terminal, and the wavelength tunable light module 152 converts upward data U_{N} inputted from the subscriber terminal to an optical signal having a preset wavelength and transmits the optical signal to the second optical fiber 140 through the CWDM filter 153. The CWDM filter 153 connected to both of the optical receiver 151 and the light source module 152 separates upward and downward optical signals of a subscriber simultaneously transmitted through the second optical fiber 140 for each wavelength.

In addition, An optical multiplexing/de-multiplexing unit 113 of the central base station 110 and an optical multiplexing/de-multiplexing unit 131 of the remote node 130 may be configured as one arrayed wave guide grating (AWG). In this case, it is preferable that a difference in wavelength between an upward channel and a downward channel is a free spectral range (FSR). For example, the upward channel and the downward channel is implemented to satisfy a DWMM rule of less than 20 nm, for example, 0.8 nm, 1.6 nm, etc., in order to preclude interchannel cross-talk.

At this time, even when environmental temperature is changed, since the wavelength tunable light source module 152 maintains wavelengths through temperature control, the interchannel cross-talk can be precluded although the difference between channels is FSR.

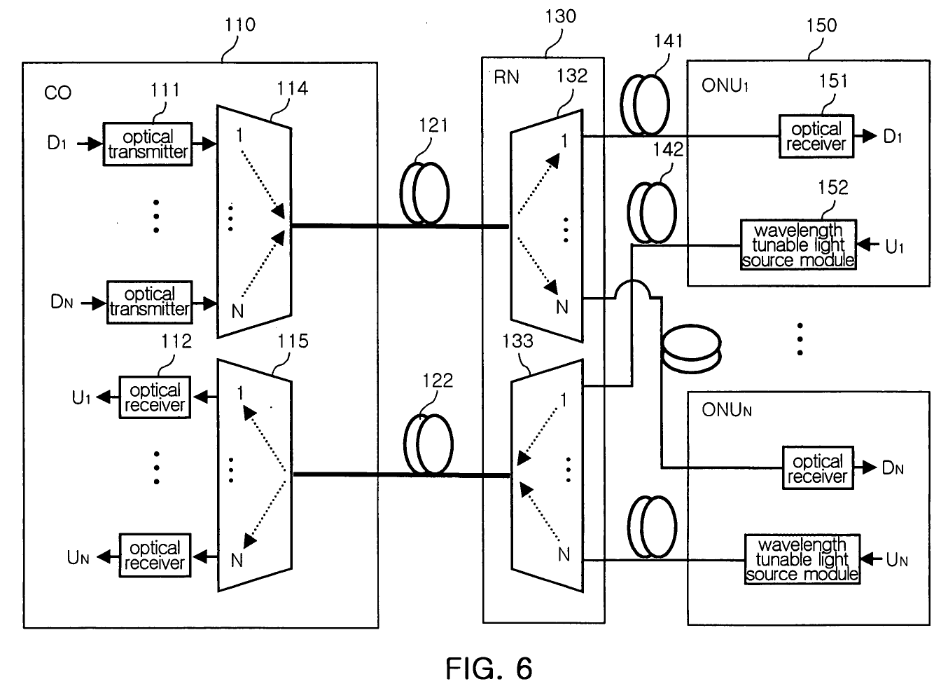

Next, FIG. 6 shows another optical network system. The optical network system of FIG. 6 is different from the optical network system of FIG. 5 in that the former use two pairs of optical fibers 121 and 122; 141 and 142 as communication paths connected between the central base station 110 and the ONUs 150 for transmitting upward signals and downward signals, respectively.

More specifically, the central base station 110 is connected to the remote node 130 via a first downward optical fiber 121 and a first upward optical fiber 122, and the remote node 130 is connected to the plurality of ONUs 150 via a second downward optical fiber 141 and a second upward optical fiber 142. The upward signals and the downward signals are transmitted via different optical fibers. Accordingly, there may be no difference in wavelength between the upward signals and the downward signals, which results in accommodation of more subscribers. Other configurations and operations are similar to those of FIG. 5.

That is, the wavelength tunable light source module 152 according to the present invention is provided in the ONUs 150 at the subscriber side and the operation wavelengths are differently set, as described above.

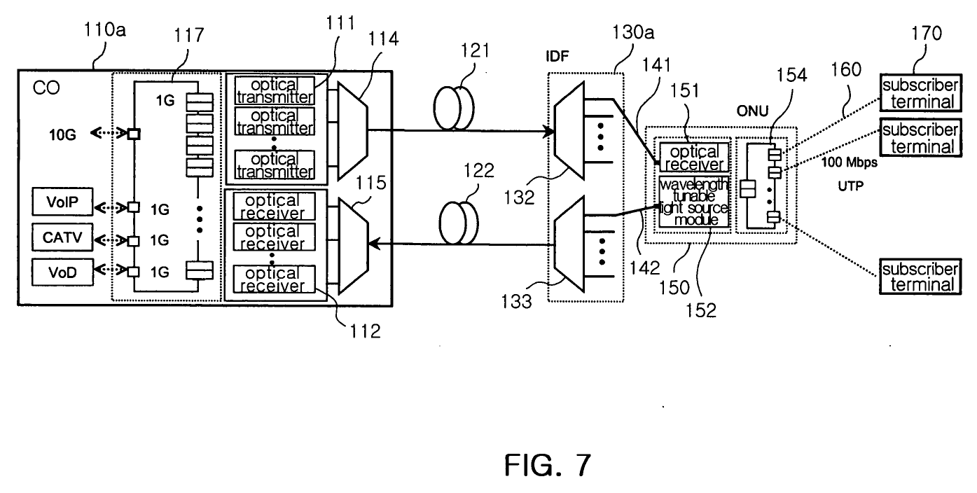

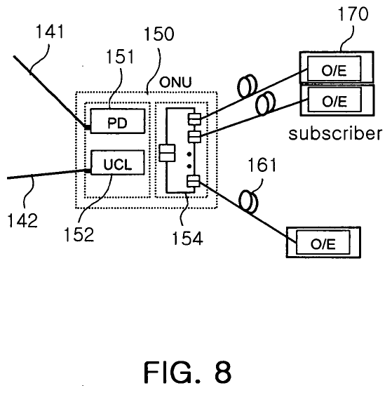

The above-described WDM-PONs of FIGS. 5 and 6 employ a fiber to the home (FTTH) scheme where one wavelength is allocated for each subscriber. Alternatively, the optical network networks can be implemented by a fiber to the pole (FTTP) scheme for distributing optical fibers near to the subscribers. FIGS. 7 and 8 show optical network systems of the FTTP scheme.

Referring to FIG. 7, the WDM-PON of the FTTP includes a central base station 110a for converting data received from different networks or servers to optical signals and converting optical signals received from subscribers to electrical signals to be transmitted to the different networks or servers, an intermediate distribution frame (IDF) 130a connected between the central base station 110a and the subscribers for relaying the optical signals, and an ONU 150 for converting downward optical signals received from the central base station 110a via the IDF 130a to the electrical signals, transmitting the electrical signals to terminals 170 of corresponding subscribers, and transmitting upward data received from the subscriber terminals 170 as optical signals having certain wavelengths. At this time, the central base station 110a and the IDF 130a are connected each other by the optical fibers 121 and 122 for an upward channel and a downward channel, respectively. Also, the IDF 130a and the ONU 150 are connected each other by the optical fibers 141 and 142 for an upward channel and a downward channel, respectively.

The ONU 150 includes an optical receiver for converting downward optical signals inputted via the second downward optical fiber 141 to electrical signals, a wavelength tunable light source module 152 for converting upward optical signals to optical signals having preset wavelengths, and an Ethernet switch 154 for distinguishing upward and downward data between the optical receiver 151, the light source module 152, and the plurality of subscribers 154. The Ethernet switch 154 is connected to a plurality of subscriber terminals 170 by unshielded twisted pairs (UTP). In the above configuration, as shown in FIGS. 5 and 6, the ONU 150 includes the wavelength tunable light source module according to the present invention, so that the ONU 150 can have stable operational characteristics and can be implemented with inexpensive costs, regardless of temperature variation. As a result, intervals between channels can become narrower, which results in accommodation of more subscribers. In addition, since the ONU 150 is connected to the plurality of subscriber terminals 170 via the Ethernet switch 154, more subscribers can be accommodated in one optical channel. However, although such a FTTP scheme has an advantage in that a great number of subscribers can be accommodated with the defined number of wavelengths, it has a limitation to a transmission distance of data via the UTP 160.

A FTTH active optical network (AON) system, as shown in FIG. 8, is a system employed for overcoming the limitation to the transmission distance to the ONU 150 and the subscriber terminals 170.

Referring to FIG. 8, the FTTH AON system has the same basic configuration, including the central base station 110a, the first upward and downward optical fibers 121 and 122, and the IDF 130a, as that of FIG. 7, except that the ONU 150 is connected to the subscriber terminals 170 by third optical fibers 161 via FX down-link ports. At this time, the subscriber 170 must have a photoelectric converter for converting optical signals to electrical signal and vice versa. Then, since a distance from the ONU 150 to the subscriber terminals 170 can be prolonged, more flexible network designs are possible.

Here, since the wavelength tunable light source module of the present invention outputs optical signals having constant wavelengths regardless of temperature variation, wavelength intervals between channels can become narrower, which results in accommodation of more subscribers. In addition, the wavelength tunable light source module can be manufactured with inexpensive costs, and accordingly, costs required for establishment of optical network systems can be saved. This leads to reduction of subscriber's load.

As apparent from the above description, according to the present invention, since a wavelength tunable light source module can be implemented using an inexpensive TO-can type DFB-LD, costs required for implementation of the wavelength tunable light source module itself and an optical network system using the same can be reduced. In addition, since an operation wavelength of the TO-can type DFB-LD is variable, wavelength intervals between channels can be reduced when the WDM-PON is established. As a result, more subscribers can be accommodated in the limited frequency band and it is possible to establish more inexpensive optical network systems. Furthermore, since it becomes possible to use an AWG for optical multiplexing/de-multiplexing, costs required for implementation of the optical network systems can be reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A wavelength tunable light source module comprising:
a temperature adjustment unit for raising or lowering ambient temperature according to heat generation or heat absorption caused by an electrical signal;
a support block attached to the temperature adjustment unit and having a structure for fixing a laser diode; and
a distributed feedback laser diode mounted on the temperature adjustment unit by the support block and having an operation wavelength varied according to the ambient temperature adjusted by the temperature adjustment unit.

2. The wavelength tunable light source module as set forth in claim 1, where the distributed feedback laser diode is an uncooled TO-can type distributed feedback laser diode.

3. The wavelength tunable light source module as set forth in claim 1, where the support block is made of a metal material having high thermal conductivity.

4. The wavelength tunable light source module as set forth in claim 1, where the temperature adjustment unit comprises:
a thermal electric cooler attached to the bottom of the support block for generating or absorbing heat when a direct current is applied to the distributed feedback laser diode and lowering operation temperature of the distributed feedback laser diode; and
a base attached on the bottom of the thermal electric cooler and made of material having high thermal conductivity or heat sink for ejecting heat generated when the thermal electric cooler is operated.

5. The wavelength tunable light source module as set forth in claim 1, where the temperature adjustment unit comprises a heater chip attached on the bottom of the support block for raising the ambient temperature by generating heat by an operation power, the heater chip containing a temperature measurement device.

6. The wavelength tunable light source module as set forth in claim 1, where the temperature adjustment unit, the support block, and the distributed feedback laser diode are mutually bonded by means of a thermal compound having good thermal conductivity or an epoxy resin.

7. The wavelength tunable light source module as set forth in claim 1, where the support block has a rectangular parallelepiped fixation groove for fixing the distributed feedback laser diode.

8. The wavelength tunable light source module as set forth in claim 4, further comprising a thermistor mounted on the support block for measuring the operation temperature of the distributed feedback laser diode.

9. The wavelength tunable light source module as set forth in claim 4, further comprising an adiabatic cover made of a material having low thermal conductivity for isolating the support block from the external environments.

10. The wavelength tunable light source module as set forth in claim 9, where a space between the support block and the adiabatic cover is filled with an adiabatic material, so that an adiabatic effect is further enhanced.

11. The wavelength tunable light source module as set forth in claim 5 or 8, further comprising a temperature control circuit for receiving a temperature measurement value of the temperature measurement device or the thermistor, detecting a difference between a reference temperature and the temperature measurement value, and controlling the temperature adjustment unit such that the operation temperature of the distributed feedback laser diode is maintained at the reference temperature.

12. A wavelength division multiplexing passive optical network systems including optical line terminal and optical network units, containing the wavelength tunable light source module as set forth in any one of claims 1 to 11 for generating optical signals having preset unique wavelengths for each channel.
